(19) United States
(12) Patent Application Publication
(10) Pub. No.: US 2013/0124273 A1
(43) Pub. Date: May 16, 2013

(54) Systems and Methods for Customer Loyalty Program

(71) Applicant: Rishi Chhabra, San Jose, CA (US)

(72) Inventor: Rishi Chhabra, San Jose, CA (US)

(73) Assignee: VISA INTERNATIONAL SERVICE ASSOCIATION, San Francisco, CA (US)

(21) Appl. No.: 13/543,369

(22) Filed: Jul. 6, 2012

Related U.S. Application Data
(60) Provisional application No. 61/505,996, filed on Jul. 8, 2011.

(51) Int. Cl. G06Q 30/02

(52) U.S. Cl. CPC G06Q 30/0229
USPC 705/14.3

(57) ABSTRACT

As a customer conducts qualifying transactions with a participating merchant within a group of merchants, the customer accumulates reward points which can be redeemed at any participating merchant within the group at the time of redemption. A promotion/award determination engine and associated database track the points. A redemption engine is coupled to the database for the redemption of the points.

### CROSS-REFERENCE TO RELATED APPLICATIONS

The present application claims the benefit of Prov. U.S. Pat. App. Ser. No. 61/505,996, filed Jul. 8, 2011 and entitled “Customer Loyalty Program,” the disclosure of which is hereby incorporated herein by reference in its entirety.

The present application is related to the subject matter of U.S. patent application Ser. No. 12/424,241, filed Apr. 15, 2009, entitled “Loyalty Rewards Optimization Bill Payables and Receivables Service”, U.S. patent application Ser. No.12/896,632, filed Oct. 1, 2010, entitled “Systems and Methods to Provide Loyalty Programs”, U.S. patent application Ser. No. 12/411,010, filed Mar. 28, 2012, entitled “Universal Loyalty Program Device” and U.S. patent application Ser. No. 13/485,645, filed Can 31, 2012, entitled “Local Usage of Electronic Tokens in a Transaction Processing System”, the disclosures of which are all hereby incorporated herein by reference in their entirety.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF TECHNOLOGY

This disclosure relates, in general, to systems and methods for loyalty programs that accumulate points for customers for their purchases within a group of merchants.

### BACKGROUND

Some businesses provide customer loyalty programs. Frequently these programs employ some type of “give back” to customers to encourage repeat purchases or continued association. Many loyalty programs fall into one of the following categories:
Appreciation: Giving the customer more of a product or service.
Reward: Giving the customer a product unrelated to the purchased product or service (e.g., a bank giving away a toaster).
Rebate: Giving customers money back for a particular purchase.
Discount: Giving customers a discount off of future purchases based on a type or value of a current purchase.

Such loyalty programs can be associated with a credit card, or other financial vehicle, and processed through a payment and settlement system. A conventional credit card processing system includes a cardholder who makes a purchase from a merchant using a credit card of the cardholder issued by an issuer, such as the cardholder's financial institution or bank, to identify a payment account.

To process a transaction, the merchant typically uses a point-of-sale device, which transmits a payment authorization request to an acquirer such as the merchant's bank. The acquirer transmits the payment authorization request, which typically includes, among other things, the merchant identification, the credit card number, and the requested dollar amounts, to the issuer through a transaction handler or payment system. If the issuer determines that the authorization requests should be granted, the issuer generates an authorization response message indicating that the request is approved, which is transmitted through the transaction handler to the acquirer and ultimately to the merchant. The merchant then completes the transaction with the cardholder. During settlement, the acquirer sends the charges through the transaction handler to be processed by the issuer, which pays the acquirer and later charges the cardholder for the purchase and reflects such charges in a cardholder statement; and then the acquirer pays the merchant for the cardholder's purchases.

### BRIEF DESCRIPTION OF THE DRAWINGS

The embodiments are illustrated by way of example and not limitation in the figures of the accompanying drawings in which like references indicate similar elements.

FIG. 1 illustrates an embodiment of a network connection of point-of-sale devices, acquirer processors, a transaction handler, promotion/award determination engines and associated databases, and issuer processors according to an embodiment.

FIG. 2 illustrates an embodiment f a flow of information from a cardholder through a system to grant, accumulate, and redeem points.

FIG. 3 illustrates an embodiment of a database system.

FIG. 4 illustrates an embodiment of a computer system compatible with implementing the systems and methods of this disclosure.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. In some instances, the terminology and symbols can imply specific details that are not required to practice the teaching.

Reference in this specification to “an embodiment” or “an embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which can be exhibited by some embodiments and not by others. Similarly, various requirements are described which can be requirements for some embodiments but not other embodiments. In some instances, the terminology and symbols can imply specific details that are not required to practice the teaching.

For the purposes of the present disclosure, the term “engine” should be understood to refer to one or more related processes implemented on one or more computing devices. In various embodiments, such processes can be implemented using computer program instructions, These computer program instructions can be provided to a processor of a general purpose computer, special purpose computer, ASIC, or other programmable data processing apparatus, such that the instructions, which execute via the processor of the computer or other programmable data processing apparatus, implements the functions/acts described with reference to the engine.

In various embodiments, the present disclosure relates to systems and methods for providing a customer loyalty program for a group of businesses. In an embodiment, a network of merchants forms a coalition where points earned from one merchant in the past can be used with any other current participants in the network. Member merchants can leave or join the group without impacting the validity of awards earned by a cardholders. In various embodiments, such merchants may or may not have any legal or business relationship with one another. For example, the group can be geographically based, such as merchants within a particular zip code or area code. Or the group can be comprised of members who are independent business owners, members of a particular organization (e.g., the local chamber of commerce), have a certain numerical range of employees, or have revenue within particular limits.

In various embodiments, the cash value of the points can be collected from the merchant sponsor at the time the points are earned (while the merchant is still in the network), or the merchants can purchase the points from a third-party (e.g. a transaction handler such as VISA) and then award them to their customers. Additionally or alternatively, the sponsors of the points earned by a customer are tracked and at the time of redemption, the cash value of the redeemed points is transferred from the sponsor to a merchant to settle the cost of the point. If a merchant is about to leave the network, the funds the merchant committed to the already awarded points can need to be collected into a specific account for future redemption.

In an embodiment, member businesses of such a coalition can give points to customers through a credit, debit, or pre-paid financial arrangements (collectively referred to hereinafter as a “card”) employing a transaction processing system. Using a specialized or non-specialized card at a participating merchant in the group, a customer earns points that can be used at any merchant within the group.

Examples of “points” include, but are not limited to:
a loyalty award,
a promotion,
a reward,
a discount,
a rebate,
a sweepstakes entry,
miles,
an instant-win award,
a product or service upgrade,
or any form of award given in exchange for card usage now known or later to be developed in the art.

Examples of the “card” include, but are not limited to:
credit cards,
debit cards,
bank cards,
store-issued cards,
prepaid cards,
contactless cards,
gift cards, or any conventional payment card or account that a customer can use in lieu of a cash or paper check payment now known or later to be developed in the art.

For example, upon making a purchase decision at a participating merchant, the cardholder presents a card and/or account identification information, to the merchant who processes it using a point-of-sale device. Examples of “cardholder” include, but are not limited to, a user of any type of card or account discussed above. Examples of “point-of-sale device” include, but are not limited to, a transaction terminal. In an embodiment, a customer can use a card with any member of the group of merchants at a point-of-sale device. In return, the customer earns points in an awards program which can be redeemed at any of the currently participating merchants in the group.

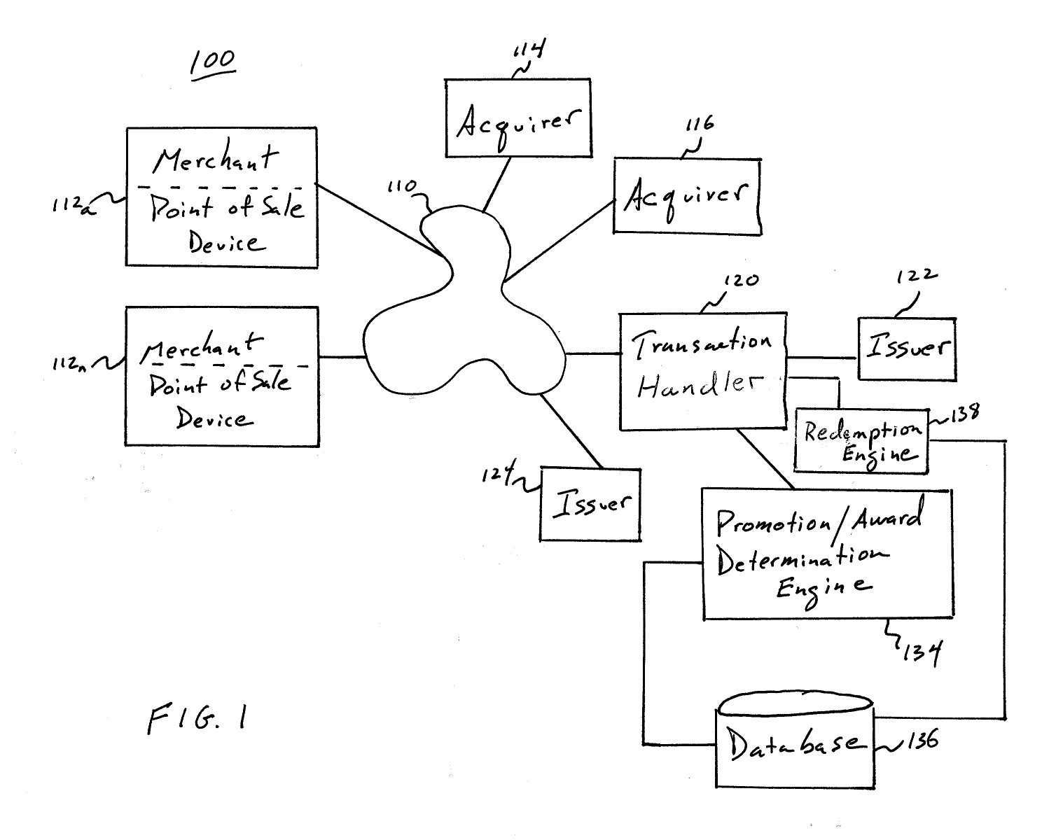

The point-of-sale device communicates merchant identification, a card number, and requested dollar amounts to an acquirer. Examples of “acquirer” include, but are not limited to, the merchant's bank or financial institution. Referring to system 100, illustrated in FIG. 1, participating merchant point of sale devices 112a and 112n are connected to a data communication network 110 and thereby to an acquirer processor such as one of acquirer processors 114 and 116.

In an embodiment, acquirer processors 114 and 116 are connected via the network 110 to a transaction handler 120 that couples to a promotion/award determination engine 134. Examples of “transaction handler” include, but are not limited to, an electronic payment system as well as any payment processing network and/or system for authorizing electronic payments and/or settling such payments between entities such as acquirers and issuers such as, for example, VISA. Examples of transactions processed by the transaction handler include, but are not limited to, transactions initiated by the cardholder physically presenting a credit card to a merchant for swiping or other data entry or providing credit card information to a merchant when the card is not physically present at the merchant's location, such as via a remote terminal, through use of a computer connected to the Internet, or over the telephone.

In an embodiment, a promotion/award determination engine is in communication with an acquirer processor 114, 116, or an issuer 122, 124, bypassing the transaction handler 120, when the network of participating merchants use the same acquirer. Examples of “issuer” include, but are not limited to, the issuer of the card of account discussed above, the cardholder's bank, or financial institution. In an embodiment, when cardholders are associated with the same issuer, a promotion/award determination engine can be connected to the issuer.

In an embodiment of FIG. 1 the promotion/award engine 134 communicates with the issuer 122, 124 and acquirer 114, 116 through transaction handler 120, to allow merchants of different acquirers to participate in the reward program and to allow cardholders of different issuers to benefit from the reward program.

In an embodiment, the promotion/award determination engine 134, employing database 136, and with access to award rules, determines whether the customer is entitled to accumulate points or redeem points. In an embodiment, the award rules determine whether the customer has to enroll in a reward program in order to obtain points. In an embodiment, the engine 134 determines if the merchant is within the current participating group in order for it to authorize awarding or redeeming points. In an embodiment, a qualified transaction with a current participating merchant enrolled in the reward program can earn points. Upon making its determination of granting points in accordance with the award rules, the promotion/award determination engine 134 updates its database to record the points granted to an account.

A redemption engine 138 is coupled to the database 136 and with access to redemption rules. The redemption rules determine whether a transaction is entitled to redeem points accumulated under the account number of the cardholder. The redemption engine 138 processes the redemption request and the redemption amount, if any, and authorizes a discounted payment amount.

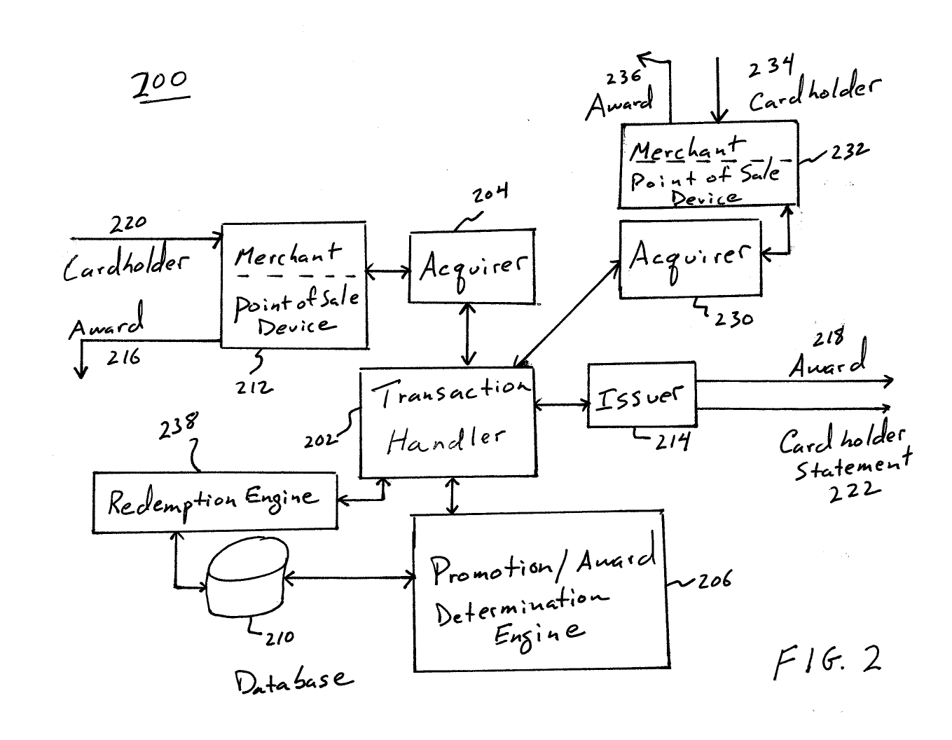

FIG. 2 illustrates a block diagram of an embodiment of financial-transaction processing system 200 including transaction handler 202. The system 200 includes a promotion/awards determination engine 206, a redemption engine 238, and a database 210, in accordance with an embodiment. In an embodiment, the database stores the identity information of the current group of merchants enrolled to provide awards to customers for use within the group of merchants, and allow the awards to be redeemable at any member of the group. Merchant point-of-sale devices 212 and 232 are connected to acquirer processors 204 and 230 respectively. In turn, the acquirer processors 204 and 230 are connected to a transaction handler 202 that can be comprised of one or more computers. The transaction handler 202 is connected to at least one issuer 214. In an embodiment, acquirer processors 204 and 230 forward information regarding a particular card transaction through the transaction handler 202 to promotion/award determination engine 206 and associated database 210.

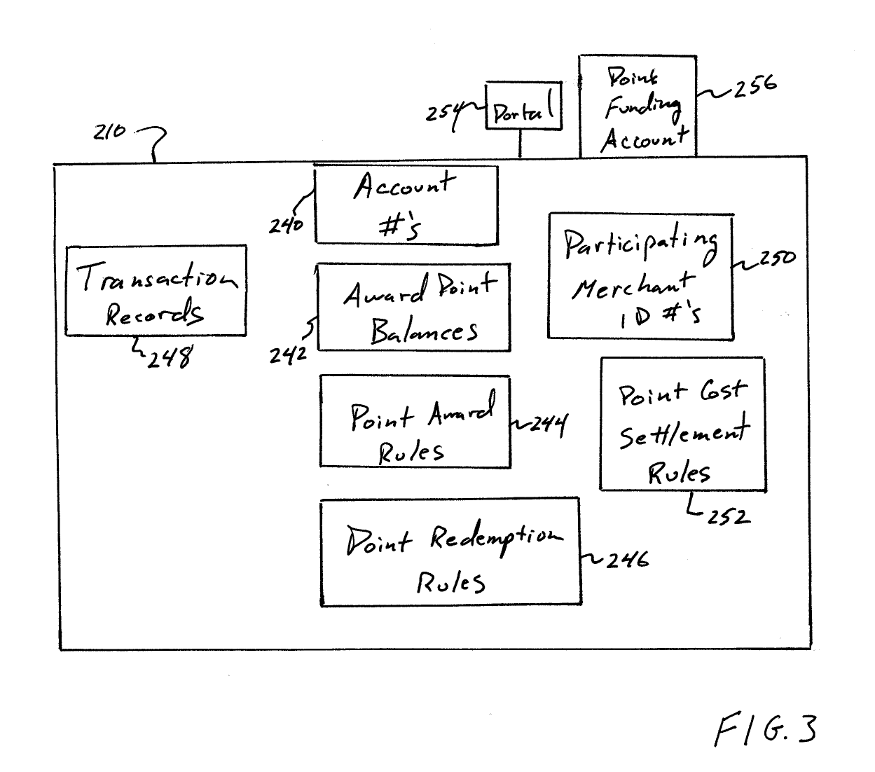

In an embodiment, the promotion/award determination engine 206 processes transaction data to determine award status. The engine 206 accesses the data, including transaction records and award rules, from database 210, shown, in an embodiment, in detail in FIG. 3. Stored data in database 210 include cardholder account numbers 240, reward point balance information 242, point award rules 244, point redemption rules 246, transaction records 248, a list of current participating merchants 250, and point cost settlement rules 252. In addition, database 210 can connect to a portal 254 and point funding account 256.

In an embodiment, from a record of a transaction passed to it via the transaction handler 202, the engine 206 compares a merchant identification number of the transaction against a list of identification numbers of participating merchants 250 contained in database 210 to determine if the transaction is entitled to points. If customer enrollment is required, it determines whether the cardholder is eligible for an award program sponsored by the group in an embodiment. In an embodiment, the award rules can specify other criteria for a qualified transaction, such as the time of the transaction, the amount of the transaction, etc. Based on the information, and point awarding rules 244, a cardholder's award point balance 242 is updated by the engine 206. In an embodiment, based on the point cost settlement rules 252, the engine determines the price, if any, that the merchant or other sponsors pays for the points awarded in response to the current transaction.

In an embodiment, based on the point redemption rules, the cardholder can redeem part or all of the award point balance 242. For example, using a web portal of the engine, the cardholder can view the point balance and request the redemption of an amount of points as a virtual gift card usable at one of the participating merchants. In an embodiment, when the cardholder makes the qualified transaction, the amount of points is deducted from the account and the user is given a statement of credit for the redeemed amount and the merchant is paid with corresponding amount from the account (256) funding the points.

In an embodiment, the redemption rules allow automated point redemption without user having to request via the portal. The redemption rule is based on transaction time, location, and/or amount. Point funding account 256 is configured to hold the funds to finance the cost of points. In an embodiment, portal 254 is coupled to the database for outside inquiries to obtain, for example, information regarding balances.

In an embodiment, information about the awards 216 and 234 is provided to cardholders 220 and 234 at the point-of-sale in real-time (e.g., via mobile alert, email notification, purchase receipt). In an embodiment, the merchant 212, 232 can provide information about accumulated or redeemed points to the customer, and/or the issuer can provide this award information 218 to the customer/cardholder in a statement 222.

In various embodiments, there can be several ways, singly or in combination, to fund the loyalty program. In an embodiment, the program be “pre-funded” in which merchants pay for points as they are given to customers. When engine 206 determines that an amount of points is to be awarded to the cardholder in response to a transaction, the transaction handler charges the merchant for the cost of the points (e.g., via the settlement of the transaction, which a portion of the amount paid by the issuer is deposited in the account 256).

In an alternative embodiment the program is “post-funded” where merchants pay for points as they are redeemed. To support the post-funded model, the award information recorded for the account 240 includes the list of points earned on a specific date from a specific merchant. In an embodiment, in settling the point redemption transaction, the transaction handler charges the respective merchants that provided the points that are being redeemed to collect funds and provide the collected funds to the current merchant at which the points are used. In an embodiment, the transaction handler generates the secondary transactions to collect the funds in response to the transaction that uses the points.

In an embodiment, merchants in the group pay a monthly fee, pay based on performance with a discount for higher numbers and amounts of transactions, or pay through a barter system. The system can also be funded partly or entirely by the card company.

In an embodiment, group members can leave or join the group from time to time. Thus, rules 244, 246, 252 can be configured to cover this situation. For example, a cardholder can obtain some points from a first merchant and some points from a second merchant, who subsequently leaves the group. Then the cardholder can desire to redeem the points at a third merchant. According to an embodiment, the rules can require the second merchant to prepay for the points the second merchant awarded to the cardholder via the “pre-funded” model. Or, otherwise, the second merchant can pay for outstanding points upon leaving the group. In yet another embodiment, the third merchant pays for points upon redemption. In any event, the number of points in the cardholder's account, in many embodiments, is not affected by members joining or leaving the group.

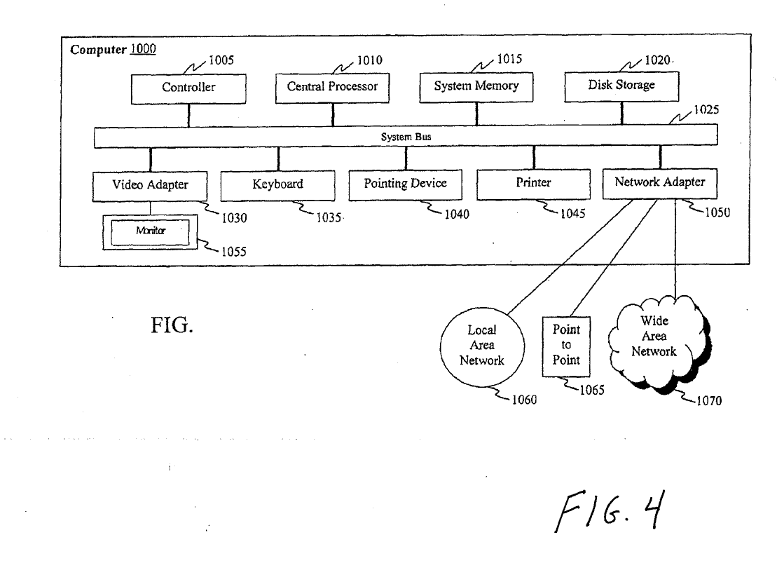

Referring to FIG. 4, a system is shown which includes a digital processing apparatus. This system includes a computer 1000, which can be used to implement components of a customer loyalty system according to an embodiment, such as transaction handler 120 acquirer processors 114, 116, issuer processors 122, 124, merchant point-of-sale devices 112a, 112n, and promotion/award determination engine 134.

Transaction handler 120 can comprise one or more computers configured to handle arriving transactions. Likewise, acquirer processors 114, 116, issuer processors 122, 124, merchant point-of-sale devices 112a, 112n, and promotion/award determination engine 134 and respective database 136 can comprise computers. A cardholder/customer can make purchases utilizing a computer such as a mobile device (e.g., laptop, notebook, tablet, mobile telephone, or PDA) or a desktop device.

The computer 1000 can include a graphics display, print hardware, and print software, can be as simple as a generic personal computer, desktop computer, laptop computer, or can be configured to perform transaction processing. The computer can be incorporated into a cellular telephone, personal digital assistant, tablet computer, network enabled television set, or any other internet connected device. The example computer in FIG. 3 includes central processor 1010, system memory 1015, optional data storage 1020 (e.g., hard drive, CD-ROM drive, non-volatile memory such as flash memory, or DVD drive), controller 1005, network adapter 1050, video adapter 1030, and monitor 1055. Data input can be through one or more of the following agencies: keyboard 1035, pointing device 1040, disk storage 1020, local area network 1060, point to point communications 1065, and wide area network 1070 (e.g., internet).

One or more features of the computer as shown can be omitted while still permitting the practice of various embodiments. For example, printer 1045 is not necessary for images to be displayed on monitor 1055. Any combination of monitor 1055, keyboard 1035, and pointing device 1040 can be omitted for a computer performing “back-office” work. Likewise, local area network 1060, point to point communications 1065, and wide area network 1070 singly or collectively can be employed.

The various acts in a method or process can be performed in the order shown, or can be performed in another order. Additionally, one or more process or method acts can be omitted or one or more process or method acts can be added to the methods and processes. An additional act, block, or action can be added in the beginning, end, or intervening existing elements of the methods and processes. Based on the disclosure and teachings provided herein, a person of ordinary skill in the art will appreciate other ways and/or methods for various implementations. Moreover, it is understood that described methods or processes, and combinations thereof can be implemented by computer program instructions. The instructions can be included in a computer readable medium that can be loaded onto a general purpose computer, a special purpose computer, or other programmable apparatus.

While the particular system, apparatus, and method for customer loyalty program as herein shown and described in detail, is fully capable of attaining the above-described objects of the embodiments, it is to be understood that it is the presently preferred embodiment, and is thus representative of the subject matter which is broadly contemplated, that the scope fully encompasses other embodiments which can become obvious to those skilled in the art, and that the scope is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are encompassed by the present claims. Moreover, it is not necessary for a device or method to address each and every aspect for it to be encompassed by the present claims. Furthermore, no element, component, or method in the present disclosure is dedicated to the public, regardless of whether the element, component, or method is explicitly recited in the claims.

1. A method comprising:
associating, using a computing device, a first entity and a second entity with a loyalty program;
receiving, using the computing device, from the first entity, information relating to a first transaction between a user eligible to participate to in the loyalty program and the first entity, the information relating to a transaction comprising an identification of a user account and an identification of the first entity;
determining, using the computing device, using the information relating to the first transaction, that the first transaction entitles the user to an award;
in response to determining that the first transaction entitles the user to the award, increasing, using the computing device, a total awards balance associated with the user account by an amount of the award;
receiving, using the computing device, from the second entity, information relating to a second transaction between the user and the second entity, the information relating to the second transaction comprising an identification of the user account, an identification of the second entity and an awards redemption request, the awards redemption request comprising an awards redemption amount;
determining, using the computing device, using the information relating to the second transaction, that the second transaction entitles the user to the awards redemption amount; and
in response determining, that the second transaction entitles the user to the awards redemption amount,
providing, using the computing device, the award redemption amount to the user, and
decreasing, using the computing device, the total awards balance associated with the user account by the awards redemption amount, such that at least a portion of the awards redemption amount relates to the award.

2. The method of claim 1 wherein the first entity is charged an award cost relating to the award in response to determining that the first transaction entitles the user to the award.

3. The method of claim 1 wherein the first entity is charged an award cost relating to the award in response providing the award redemption amount to the user.

4. The method of claim 1 wherein the first entity is disassociated from the loyalty program prior to the second transaction, such that the total awards balance is not affected.

5. The method of claim 5 wherein the first entity is charged an award cost relating to the award in response the disassociation of the first entity from the loyalty program.

6. The method of claim 1 wherein providing the award redemption amount to the user comprises discounting an amount of the second transaction by the award redemption amount.

7. The method of claim 6 additionally comprising:
paying, using the computing device, the second entity the award redemption amount.

8. The method of claim 1 additionally comprising:
receiving, using the computing device, from the user, a request for a gift card, the request for a gift card comprising a gift card amount;
determining, using the computing device, using the request for a gift card, that the user is entitled to the gift card; and
in response determining the user is entitled to the gift card,
providing the gift card to the user, such that the gift card is valid for transactions with the first entity and the second entity, and
decreasing, using the computing device, using the total awards balance associated with the user account by the gift card amount, such that at least a portion of the gift card amount relates to the award.

9. The method of claim 1 additionally comprising:
providing, using the computing device, a status of the total awards redemption amount.

10. The method of claim 9 wherein the status of the total awards redemption amount is provided to the user via at least one of: a web portal, a mobile alert, or an email notification.

11. The method of claim 9 wherein the status of the total awards redemption amount is provided to the second entity in response to providing the award redemption amount to the user.

12. The method of claim 1, wherein determining that the first transaction entitles the user to an award comprises determining, using the identification of the first entity, that the first entity is associated with the loyalty program.

13. The method of claim 12 wherein determining that the first transaction entitles the user to an award additionally comprises matching at least one property of the first transaction to an award rule.

14. The method of claim 12 wherein the at least one property of the first transaction is a transaction amount and time.

15. The method of claim 13 wherein the at least one property of the first transaction is a transaction location.

16. The method of claim 1 wherein the first transaction and the second transaction relate to the use of a card.

17. The method of claim 17 wherein the card is selected from the list:
a credit card, a debit card, a bank card, a store-issued card, a prepaid card and a contactless card.

18. The method of claim 1 wherein the award is selected from the list: a loyalty award, a promotion, a reward, a discount, a rebate, a sweepstakes entry, miles, an instant-win award, and a product or service upgrade.

19. A non-transitory computer-readable storage medium storing computer-readable instructions, which when executed, cause a system to perform:
associating a first entity and a second entity with a loyalty program;
receiving, from the first entity, information relating to a first transaction between a user eligible to participate in the loyalty program and the first entity, the information relating to a transaction comprising an identification of a user account and an identification of the first entity;
determining, using the information relating to the first transaction, that the first transaction entitles the user to an award;
in response to determining that the first transaction entitles the user to the award, increasing a total awards balance associated with the user account by an amount of the award;
receiving, from the second entity, information relating to a second transaction between the user and the second entity, the information relating to the second transaction comprising an identification of the user account, an identification of the second entity and an awards redemption request, the awards redemption request comprising an awards redemption amount;
determining, using the information relating to the second transaction, that the second transaction entitles the user to the awards redemption amount; and
in response determining that the second transaction entitles the user to the awards redemption amount,
providing the award redemption amount to the user, and
decreasing the total awards balance associated with the user account by the awards redemption amount, such that at least a portion of the awards redemption amount relates to the award.

20. A system comprising:
a memory storing instructions;
a processor coupled with the memory to execute the instructions, the instructions configured to instruct the processor to:
receive, from the first entity, information relating to a first transaction between a user eligible to participate in the loyalty program and the first entity, the information relating to a transaction comprising an identification of a user account and an identification of the first entity;
determine, using the information relating to the first transaction, that the first transaction entitles the user to an award;
in response to determining that the first transaction entitles the user to the award, increase a total awards balance associated with the user account by an amount of the award;
receive, from the second entity, information relating to a second transaction between the user and the second entity, the information relating to the second transaction comprising an identification of the user account, an identification of the second entity and an awards redemption request, the awards redemption request comprising an awards redemption amount;
determine, using the information relating to the second transaction, that the second transaction entitles the user to the awards redemption amount; and
in response determining that the second transaction entitles the user to the awards redemption amount,
provide the award redemption amount to the user, and
decrease the total awards balance associated with the user account by the awards redemption amount, such that at least a portion of the awards redemption amount relates to the award.
